(19) United States
(12) Patent Application Publication
(10) Pub. No.: US 2009/0135696 A1
(43) Pub. Date: May 28, 2009

(54) OPTICAL DISC APPARATUS AND SELECTION METHOD FOR EVALUATION METHODS OF RECORDING QUALITY

(75) Inventor: Yasuhiro WADA, Osaka (JP)

Correspondence Address: MCDERMOTT WILL & EMERY LLP, 600 13TH STREET, N.W., WASHINGTON, DC, 20005-3096, US

(73) Assignee: HITACHI-LG DATA STORAGE, INC.

(21) Appl. No.: 12/269,593

(22) Filed: Nov. 12, 2008

(30) Foreign Application Priority Data
Nov. 26, 2007 (JP) 2007-304737

(51) Int. Cl. G11B 27/36

(52) U.S. Cl. 369/53.31; G9B/27.052

(57) ABSTRACT

An optical disc apparatus in which a β method using a β value showing asymmetry of an amplitude of a reproduction signal or a κ method using a modulation degree of the reproduction signal is executed as an evaluation method of evaluating recording quality of data in an optical disc, wherein: the data recorded by a recording power of a different intensity is reproduced; a β value and a jitter value are obtained on the basis of the reproduced data, respectively; the β method is selected as an evaluation method of evaluating the recording quality of the data in the optical disc under such a condition that the obtained β value satisfies a predetermined requirement for the recording power of the different intensity; and a target β value is set on the basis of the obtained jitter value when the β method has been selected.

### INCORPORATION BY REFERENCE

The present application claims priority from Japanese application JP2007-304737 filed on Nov. 26, 2007, the content of which is hereby incorporated by reference into this application.

### BACKGROUND OF THE INVENTION

The invention relates to an optical disc apparatus and a selection method for evaluation methods of evaluating recording quality of data and, more particularly, the invention is suitable when it is applied to an optical disc apparatus for evaluating recording quality of data of an unknown medium.

Hitherto, in an optical disc apparatus, when data is recorded onto an optical disc, an adjusting process of a recording power called OPC (Optimum Power Calibration) is executed in order to evaluate recording quality of the data. In the OPC, prior to recording the data, predetermined data is trial-written into a trial-writing area provided on an innermost rim or the like of the optical disc and an optimum recording power is decided on the basis of a reproduction waveform of the trial-written data. As a method of the OPC, for example, a β method in which a β value showing asymmetry of an amplitude of a reproduction signal is used as an index, a κ method in which a modulation degree of the reproduction signal is used as an index, and the like have been proposed.

Techniques regarding such an OPC have been disclosed in JP-A-2005-12896, JP-A-2007-157196, JP-A-2005-209243, and JP-A-2005-149538.

### SUMMARY OF THE INVENTION

For example, on a Blu-ray disc as an optical disc, both of a parameter which is used in the β method of the OPC mentioned above and a parameter which is used in the κ method have previously been recorded as DI information. Therefore, when data is recorded onto the Blu-ray disc, the optical disc apparatus can perform the OPC according to the β method or the κ method by using those parameters of the DI information.

When comparing the β method with the κ method, according to the β method, although a result of precision higher than that in the κ method can be obtained, there is such a restriction that the target Blu-ray disc has to have predetermined characteristics. According to the κ method, on the other hand, although it can be applied to the Blu-ray discs having any characteristics, since precision is lower than that in the β method, the reliability is slightly low. In consideration of such features of the β method and the κ method, for example, information of the optimum OPC method has previously been stored in the optical disc apparatus every type of Blu-ray disc. In the optical disc apparatus, when it is tried to record data onto a certain Blu-ray disc, the OPC method which is optimum to the Blu-ray disc can be decided with reference to the information in the optical disc apparatus.

However, if the Blu-ray disc to which the user intends to record data is a disc which has been sold after the optical disc apparatus was manufactured or the like, the information of such a Blu-ray disc is not recorded in the optical disc apparatus. Therefore, if the target Blu-ray disc is an unknown medium for the optical disc apparatus, the κ method which can be applied to the optical discs having any characteristics is often used. However, it is desirable to use the β method also to the unknown medium from a viewpoint of assuring the precision of the OPC.

The parameters corresponding to the β method and the κ method have been stored in the DI information of the Blu-ray disc as mentioned above. For example, a target β value has been stored for the β method. Each manufacturing maker sets such a target β value on the basis of a β value obtained in the manufacturing step of the Blu-ray disc. However, there is a possibility that not only the β value which is obtained by recording the data onto the Blu-ray disc differs depending on the characteristics of the Blu-ray disc but also the β value differs depending on the optical disc apparatus for recording the data onto the Blu-ray disc. Therefore, the target β value included in the DI information of the Blu-ray disc does not always have the optimum value even in the case of recording the data onto the Blu-ray disc in the optical disc apparatus.

Since the information of the known medium has been stored in the optical disc apparatus as mentioned above, if the parameter of the β method or the κ method is included in the information in the optical disc apparatus, it can be also used. However, if the optical disc is an unknown medium, the parameter in the optical disc apparatus cannot be used either.

The invention is made in consideration of the above problems and intends to provide an optical disc apparatus and a selection method for evaluation methods, in which even in the case where the optical disc apparatus records data to an optical disc as an unknown medium, a precise OPC can be performed.

To solve the above problems, according to the invention, there is provided an optical disc apparatus in which a β method using a β value showing asymmetry of an amplitude of a reproduction signal or a κ method using a modulation degree of the reproduction signal is executed as an evaluation method of evaluating recording quality of data in an optical disc, comprising: a reproducing unit for reproducing the data recorded by a recording power of a different intensity; a β value obtaining unit for obtaining the β value on the basis of the data reproduced by the reproducing unit; a jitter value obtaining unit for obtaining a jitter value on the basis of the data reproduced by the reproducing unit; a selecting unit for selecting the β method as the evaluation method under such a condition that the β value obtained by the β value obtaining unit satisfies a predetermined requirement for the recording power of the different intensity; and a setting unit for setting a target β value on the basis of the jitter value obtained by the jitter value obtaining unit when the β method has been selected by the selecting unit.

According to the invention, there is provided a selection method for evaluation methods whereby a β method using a β value showing asymmetry of an amplitude of a reproduction signal or a κ method using a modulation degree of the reproduction signal is selected as an evaluation method of evaluating recording quality of data in an optical disc, comprising the steps of: reproducing the data recorded by a recording power of a different intensity; obtaining the β value and a jitter value on the basis of the reproduced data; selecting the β method as the evaluation method of evaluating the recording quality of the data in the optical disc under such a condition that the obtained β value satisfies a predetermined requirement for the recording power of the different intensity; and setting a target β value on the basis of the obtained jitter value when the β method has been selected.

According to the invention, even in the case where the optical disc apparatus records the data onto an unknown medium, the β method can be selected and the target β value can be performed in consideration of characteristics of the unknown medium, so that the precision of the OPC to the unknown medium can be assured.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a construction of an optical disc apparatus according to an embodiment;

FIG. 2 is a diagram for explaining a disc discrimination table;

FIG. 3 is a flowchart showing a processing procedure for an OPC method selecting process;

FIG. 4 is a diagram showing an example of a relation between a recording power and a β value; and

FIG. 5 is a diagram showing an example of a relation between the recording power and a jitter value.

### DETAILED DESCRIPTION OF THE INVENTION

A construction and the operation of an embodiment of the invention will be described hereinbelow with reference to the drawings.

### (1) Construction of Optical Disc Apparatus According to Embodiment

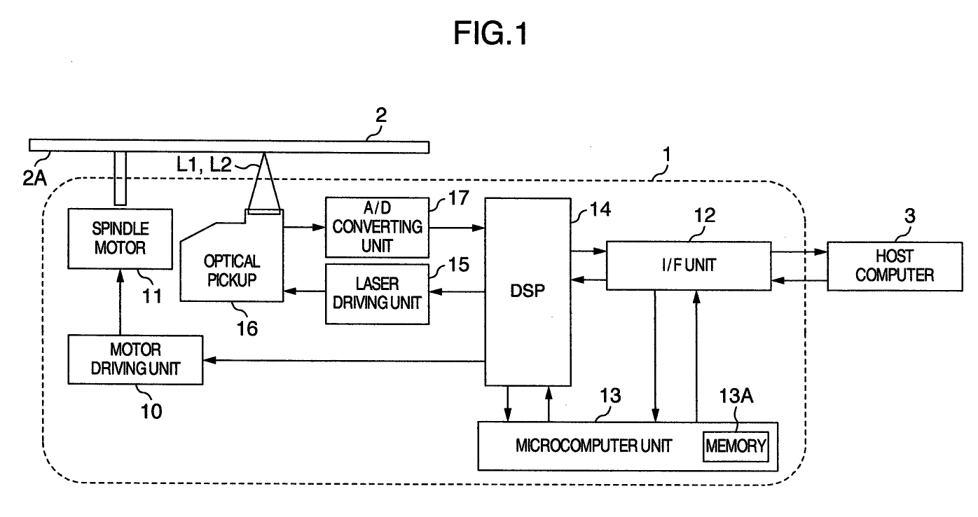

FIG. 1 shows an optical disc apparatus 1 according to the embodiment. The optical disc apparatus 1 corresponds to optical discs 2 of three types of BD, DVD, and CD as recording media and is constructed in such a manner that in response to a request from a host computer 3, data can be recorded onto the optical discs 2 or the data recorded on the optical discs 2 can be reproduced.

In the optical disc apparatus 1, a motor driving unit 10 drives a spindle motor 11 under control of a digital signal processor (DSP) 14, thereby allowing the optical disc 2 loaded in a predetermined state to be rotated in a rotating state according to a recording system (for example, a CAV system or a CLV system) of the optical disc 2.

In the optical disc apparatus 1, various kinds of commands which are transmitted from the host computer unit 3 are sent to a microcomputer unit 13 through an interface unit (I/F unit) 12.

The microcomputer unit 13 has a CPU (Central Processing Unit) and an internal memory 13A in which various control programs have been stored. The microcomputer unit 13 executes necessary control process or arithmetic operating process in accordance with commands which are supplied from the host computer 3 or various kinds of information sent from the DSP 14.

For example, when a recording command is sent from the host computer 3, the microcomputer unit 13 controls the I/F unit 12 and, thereafter, allows recording target data which is transmitted from the host computer 3 to be sent to the DSP 14.

The DSP 14 executes predetermined signal processes including a modulating process to the recording target data which is transmitted through the I/F unit 12 and sends the obtained recording signal as a driving signal to a laser driving unit 15.

The laser driving unit 15 allows a laser diode (not shown) in an optical pickup 16 to flicker on the basis of the driving signal which is sent from the DSP 14. Thus, a laser beam L1 of a flickering pattern according to the contents of the driving signal (recording signal) and a light amount according to a signal level of the driving signal is emitted from the laser diode. The laser beam L1 is converged onto a recording surface 2A of the optical disc 2 through a focusing lens (not shown) in the optical pickup 16. Thus, the recording target data is recorded onto the optical disc 2.

Reflection light L2 of the laser beam L1 from the optical disc 2 is photoelectrically converted by a photodetector (not shown) in the optical pickup 16. An RF (Radio Frequency) signal obtained by the photoelectric conversion is digitally converted by an analog/digital (A/D) converting unit 17 and sent as a digital RF signal to the DSP 14.

The DSP 14 forms various control signals such as focusing error signal, tracking error signal, rotation control signal, and the like on the basis of the supplied digital RF signal. A biaxial actuator (not shown) in the optical pickup 16 is controlled on the basis of the focusing error signal and the tracking error signal, so that focusing control and tracking control are made. The rotation control signal is sent to the motor driving unit 10. Rotation control of the spindle motor 11 is made by the motor driving unit 10 on the basis of the rotation control signal.

A part of the laser beam L1 emitted from the laser diode in the optical pickup 16 is further spectrolized before it enters a focusing lens and is photoelectrically converted by the photodetector for APC control (not shown) in the optical pickup 16. The RF signal obtained by the photoelectric conversion is digitally converted by the A/D converting unit 17 and, thereafter, sent as a digital RF signal to the DSP 14.

On the basis of the digital RF signal, the DSP 14 controls the signal level of the driving signal which is sent to the laser driving unit 15 in such a manner that the recording power is set to a target recording power which has been preset for the APC control.

When a reproduction command from the host computer 3 is received through the I/F unit 12, the microcomputer unit 13 controls the DSP 14 so as to transmit a predetermined control signal to the laser driving unit 15.

On the basis of the supplied control signal, the laser driving unit 15 turns on the laser diode in the optical pickup 16 by a predetermined voltage. Thus, the laser beam of a predetermined power is emitted from the laser diode. The laser beam is converged onto the recording surface 2A of the optical disc 2 through the focusing lens mentioned above.

The reflection light L2 of the laser beam L1 from the optical disc 2 is photoelectrically converted by the photodetector in the optical pickup 16. The obtained RF signal is digitally converted by the A/D converting unit 17 and sent as a digital RF signal to the DSP 14.

The DSP 14 executes reproduction signal processes such as a demodulating process and the like to the supplied digital RF signal and transmits the obtained reproduced data to the host computer 3 through the I/F unit 12.

The DSP 14 forms various control signals such as focusing error signal, tracking error signal, rotation control signal, and the like on the basis of the digital RF signal in a manner similar to that upon data recording. The focusing control, the tracking control, and the rotation control of the spindle motor 11 are made on the basis of the focusing error signal, tracking error signal, and rotation control signal in a manner similar to that upon data recording.

### (2) Selecting Process of OPC Method in Optical Disc Apparatus According to Embodiment

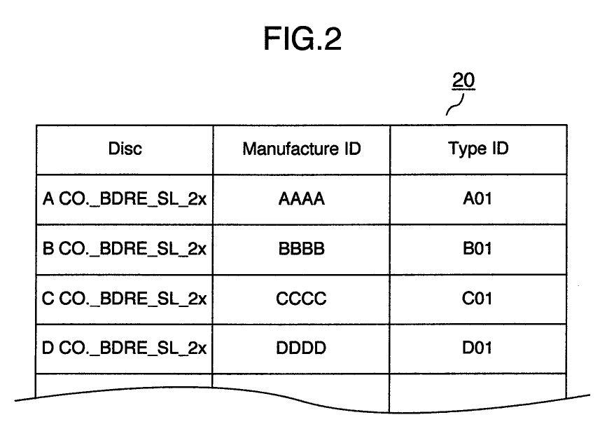

Subsequently, a selecting process of the OPC method used for the optical disc apparatus 1 will be described with reference to FIGS. 2 to 5.

The optical disc apparatus 1 according to the embodiment uses the β method and the κ method as an OPC method (recording power control method) upon recording data onto the optical disc 2, respectively. The β method is a method whereby the β value showing asymmetry of the amplitude of the reproduction waveform is used as an index, the β value which becomes a target (target β value) is set, and the optimum recording power is controlled on the basis of the recording power at which the target β value can be obtained. The κ method is a method whereby a modulation degree m showing a ratio of the amplitude of the reproduction waveform to the maximum amplitude is used as an index, a value of the modulation degree m value which becomes a target (target m value) is set, and the optimum recording power is controlled on the basis of the recording power at which the target m value can be obtained.

Information regarding the optical disc 2 has previously been recorded as DI information on the optical disc 2 by the manufacturing maker. Both of the parameter which is used in the β method and the parameter which is used in the κ method are included in the DI information.

When the optical disc 2 is a known medium, the optical disc apparatus 1 selects either the β method or the κ method in accordance with information which is stored in the memory 13A prior to executing the OPC. When the optical disc 2 is an unknown medium, the optical disc apparatus 1 selects the OPC method which is optimum to the optical disc 2 on the basis of a selecting process of the OPC method, which will be described hereinafter.

In the optical disc apparatus 1, as a unit for discriminating whether the loaded optical disc 2 is a known medium or an unknown medium, a disc discrimination table 20 as shown in FIG. 2 is provided in the memory 13A in the microcomputer unit 13.

The disc discrimination table 20 is a table for managing information regarding the optical disc 2 which is sold by each maker. For example, information such as disc name (Disc) for specifying the optical disc 2, manufacture ID (Manufacture ID) for specifying the maker, type ID (Type ID) for specifying the kind of optical disc, and the like is stored as parameters in the disc discrimination table 20 in correspondence to each other.

When the optical disc 2 is loaded into the optical disc apparatus 1, the microcomputer unit 13 of the optical disc apparatus 1 reads out the DI information (of the optical disc 2) stored in a lead-in area or an outer area of the disc and reads out the information corresponding to the DI information from the disc discrimination table 20. The microcomputer unit 13 discriminates whether or not those read-out information coincides. For example, the microcomputer unit 13 reads out the manufacture ID and the type ID from the optical disc 2 and the disc discrimination table 20, respectively, and discriminates whether or not they coincide. Which information should be read out and be made coincident can be set according to the specifications of the optical disc 2 and the optical disc apparatus 1.

If the DI information in the optical disc 2 coincides with the information in the disc discrimination table 20, the microcomputer unit 13 determines that the optical disc is the known medium. If the DI information does not coincide, the microcomputer unit 13 determines that the optical disc is the unknown medium. The microcomputer unit 13 stores predetermined information showing whether or not the optical disc is the unknown medium into the memory 13A.

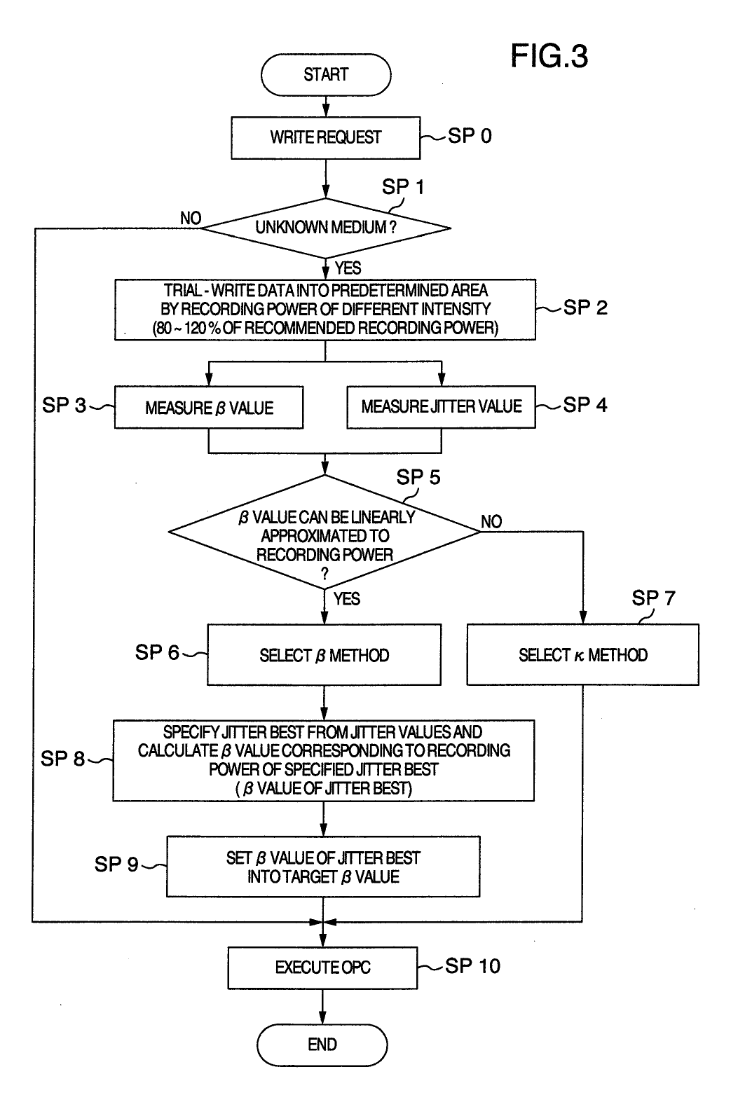

FIG. 3 is a flowchart showing a processing procedure for a selecting process of the OPC method. The selecting process of the OPC method by the optical disc apparatus 1 in the embodiment is executed under control of the microcomputer unit 13 on the basis of a control program stored in a memory 13A in the microcomputer unit 13.

When a recording command (Write request) is received from the host computer 3, the microcomputer unit 13 executes the process shown in FIG. 3 (SP0).

First, the microcomputer unit 13 discriminates whether or not the optical disc 2 loaded in the optical disc apparatus 1 is the unknown medium (SP1). If the predetermined information showing whether or not the optical disc is the unknown medium has already been stored in the memory 13A as mentioned above, the discrimination about the unknown medium can be made by referring to the predetermined information. The discrimination about the unknown medium may be made by reading out the DI information from the optical disc 2 and collating with the information in the disc discrimination table 20.

If an affirmative result is obtained in a discrimination result about the unknown medium (YES in SP1), the microcomputer unit 13 starts the selecting process of the OPC method according to the embodiment. If a negative result is obtained in a discrimination result about the unknown medium (NO in SP1), since the optical disc is the known medium, the microcomputer unit 13 selects the OPC method of the optical disc 2 by referring to the disc discrimination table 20 or the like (not shown) and executes the selected OPC method (SP10).

If it is determined that the loaded optical disc 2 is the unknown medium, the microcomputer unit 13 examines characteristics of the optical disc 2 as an unknown medium, specifically speaking, linearity of the recording power to β prior to executing the OPC and discriminates whether or not the optical disc 2 is suitable for the β method.

Specifically speaking, the microcomputer unit 13 controls the DSP 14, a seeking motor (not shown), and the like, thereby allowing predetermined data to be trial-written into a predetermined area (trial-writing area) on the optical disc 2 while changing an intensity of the recording power step by step (SP2). The trial-writing area is provided, for example, in an inner rim portion or an outer rim portion of the optical disc 2.

In the embodiment, a range from 80 to 120% of the recommended recording power is divided into 14 stages at almost regular intervals, thereby setting so that the intensity of the recording power changes step by step. A value of the recommended recording power is obtained from the DI information of the optical disc 2. A condition adapted to change the intensity of the recording power is not limited to the above example but can be arbitrarily set in consideration of the specifications of the optical disc apparatus 1 and the optical disc 2 or the like.

Subsequently, the microcomputer unit 13 controls the DSP 14, the seeking motor (not shown), and the like, thereby sequentially reproducing the data recorded in the trial-writing area, and measures the β value every recording power (SP3). When the β value is measured every recording power, the microcomputer unit 13 also simultaneously measures a jitter (Jitter) value of each recording power (SP4).

The measurement of the β value will be described here. The microcomputer unit 13 controls the DSP 14, the seeking motor (not shown), and the like, thereby sequentially reproducing the trial-writing data recorded by the recording power of the different intensity. The RF signal obtained in this instance is sequentially sent to the DSP 14 through the A/D converting unit 17.

The DSP 14 executes a predetermined signal process such as a demodulating process or the like to the digital RF signal which is supplied and executes an arithmetic operation expressed by the following equation (1) on the basis of a reproduction signal thus obtained.

β=(a1+a2)/(a1−a2) (1)

The DSP 14 transmits the measurement β value obtained by the above arithmetic operation to the microcomputer unit 13.

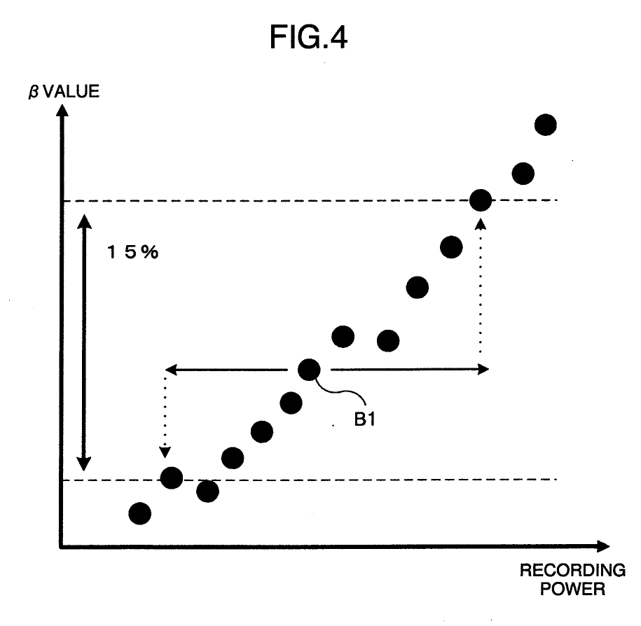

In the equation (1), a1 denotes a maximum level of the reproduction signal and a2 indicates a minimum level of the reproduction signal. The DSP 14 transmits the calculated β value to the microcomputer unit 13. FIG. 4 shows the β value of each recording power obtained as mentioned above.

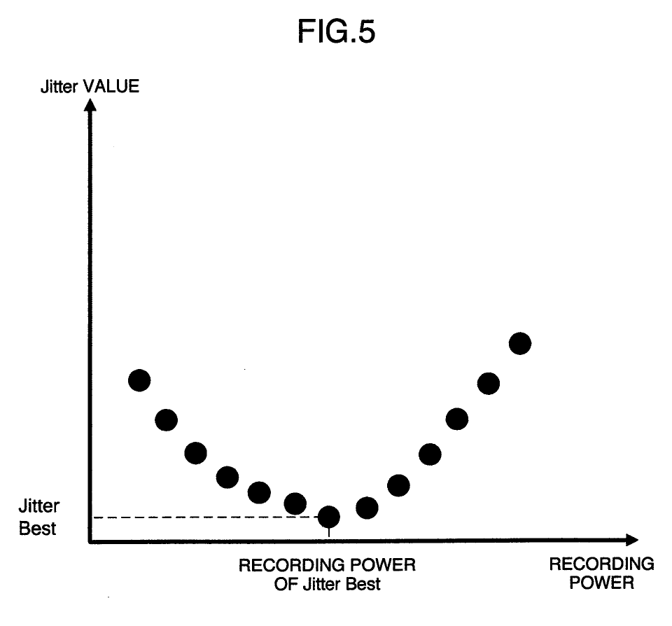

The measurement of the jitter value will be described. For example, by a TIA (Time Interval Analyzer) function, the DSP 14 measures a value of the jitter of the reproduction signal (hereinbelow, it is referred to as a “jitter value”) from the reproduction signal obtained in order to measure the foregoing β value and transmits a measurement result to the microcomputer unit 13. The measurement result is used for the calculating process of the target β value according to the embodiment, which will be explained hereinafter. FIG. 5 shows the jitter value of each recording power obtained in this manner.

When the β value of each recording power is obtained from the DSP 14, the microcomputer unit 13 discriminates whether or not the relation between the recording power and the β value satisfies the predetermined requirement (SP5). In the embodiment, when a relation of a linear approximation is satisfied between the obtained β value and the recording power, the microcomputer unit 13 determines that the predetermined requirement is satisfied (SP5).

For example, as shown in FIG. 4, the microcomputer unit 13 measures a predetermined number of β values around a β value B1, as a center, corresponding to the recommended recording power (for example, five β values before and after the β value B1). If a difference among the measured β values is equal to or larger than a predetermined percentage (for example, 15%) and the number of β values existing in such a predetermined percentage is equal to or larger than a predetermined number (for example, eight β values), it is determined that both of them are linearly approximated. A condition at the time of discriminating the linear approximation is not limited to such conditions but can be set according to various conditions in consideration of the specifications of the optical disc apparatus 1, the optical disc 2, and the like.

If an affirmative result is obtained in the discrimination about the linear approximation (YES in SP5), the microcomputer unit 13 selects the β method as an OPC method for the optical disc 2 as an unknown medium (SP6).

When the β method is selected, the microcomputer unit 13 obtains the jitter value of each recording power obtained by the trial-writing from the DSP 14. On the basis of those jitter values, the microcomputer unit 13 detects a relation between the recording power and the jitter value in the optical disc 2 as an unknown medium loaded in the optical disc apparatus 1 and calculates a point where the jitter value is minimum (hereinbelow, referred to as a “jitter best”) (SP8). As shown in FIG. 5, the microcomputer unit 13 calculates a recording power corresponding to the jitter best (hereinbelow, referred to as a “recording power of the jitter best”) (SP8).

When the recording power of the jitter best is calculated, the microcomputer unit 13 calculates a β value of the recording power of the jitter best (SP8) and sets it into the target β value (Target Beta) which is used in the OPC process (SP9). The target β value is information for deciding the optimum recording power in the OPC process of the β method. When the OPC is executed, the optimum recording power is decided on the basis of the recording power at which the target β value is obtained.

The microcomputer unit 13 controls the DSP 14, the seeking motor (not shown), and the like, thereby executing the OPC method selected for the recording medium 2 as an unknown medium (SP10). That is, if the affirmative result is obtained in the discrimination about the linear approximation (YES in SP5), the DSP 14 executes the OPC according to the β method for the recording medium 2 as an unknown medium. In the target β value which is used in the OPC of the β method, the β value of the jitter best obtained by the trial-writing has been set. The well-known technique can be used with respect to the OPC process according to the β method.

If a negative result is obtained in the discrimination about the linear approximation (NO in SP5), the microcomputer unit 13 controls the DSP 14, the seeking motor (not shown), and the like, thereby executing the κ method using the modulation degree. The well-known technique can be used with respect to the construction in which the DSP 14 executes the OPC process according to the κ method.

### (3) Advantages of Embodiment

As mentioned above, in the optical disc apparatus 1 according to the embodiment, when the optical disc 2 is an unknown medium, the relation between the recording power and β in the optical disc 2 is detected and which one of the β method and the κ method is used is determined prior to executing the OPC. Therefore, the optimum OPC method can be used to the unknown medium. Thus, precision of the OPC when recording the data onto the optical disc 2 can be assured.

In the optical disc apparatus 1 according to the embodiment, since the relation between the recording power and the jitter is detected and the β value corresponding to the jitter best among the detected jitter values is set as a target β value, the target β value which is optimum to the characteristics and states of the optical disc apparatus 1 and the optical disc 2 in the data recording mode is set.

Further, in the optical disc apparatus 1 according to the embodiment, when the β value is measured by the trial-writing, the jitter value is also simultaneously measured. Therefore, there is no need to additionally execute the trial-writing in order to set the target β value.

### (4) Another Embodiment

Although the embodiments have been described above with respect to the case where the invention is applied to the optical disc apparatus 1 corresponding to the BD, DVD, and CD, the invention is not limited to such a case. The invention can be also widely applied to another optical disc apparatus so long as it executes the OPC in order to evaluate the recording quality of data upon recording of the data.

Further, although the embodiments have been described above with respect to the case where the target β value in which the β value of the jitter best has been set is used in the control of the OPC which is executed prior to recording the data, the invention is not limited to such a case. For example, the target β value can be also used in control of a walking OPC which is executed during the recording process of the data.

Further, in the embodiments mentioned above, when the data is recorded onto the optical disc 2, the reproducing unit for reproducing the data recorded on the optical disc 2 has been constructed by the microcomputer unit 13, DSP 14, optical pickup 16, and the like. However, the invention is not limited to such a construction. As a construction of the reproducing unit, the invention can be also widely applied by using other various constructions.

Further, although the embodiments have been described above with respect to the case where the β value obtaining unit for obtaining the β value on the basis of the data reproduced by the reproducing unit and the jitter value obtaining unit for obtaining the jitter value on the basis of the data are constructed by the DSP 14, the invention is not limited to such a construction. As constructions of the β value obtaining unit and the jitter value obtaining unit, the invention can be also widely applied by using other various constructions.

Further, in the embodiments mentioned above, although the selecting unit and the setting unit have been constructed by the microcomputer unit 13 for controlling the operation of the whole optical disc apparatus 1, the invention is not limited to such a construction. A part or all of the functions of those units may be allocated to the DSP 14. A processor such as a CPU or the like may be provided separately from the microcomputer unit 13 and a part or all of the functions of those units may be allocated to such a processor.

It should be further understood by those skilled in the art that although the foregoing description has been made on embodiments of the invention, the invention is not limited thereto and various changes and modifications may be made without departing from the spirit of the invention and the scope of the appended claims.

1. An optical disc apparatus in which a β method using a β value showing asymmetry of an amplitude of a reproduction signal or a κ method using a modulation degree of the reproduction signal is executed as an evaluation method of evaluating recording quality of data in an optical disc, comprising:
a reproducing unit for reproducing the data recorded by a recording power of a different intensity;
a β value obtaining unit for obtaining the β value on the basis of said data reproduced by said reproducing unit;
a jitter value obtaining unit for obtaining a jitter value on the basis of said data reproduced by said reproducing unit;
a selecting unit for selecting said β method as said evaluation method under such a condition that the β value obtained by said β value obtaining unit satisfies a predetermined requirement for said recording power of the different intensity; and
a setting unit for setting a target β value on the basis of the jitter value obtained by said jitter value obtaining unit when said β method has been selected by said selecting unit.

2. An optical disc apparatus according to claim 1, wherein at timing when said β value obtaining unit obtains the β value on the basis of the data reproduced by said reproducing unit, said jitter value obtaining unit obtains the jitter value on the basis of said data reproduced by said reproducing unit.

3. An optical disc apparatus according to claim 1, wherein said setting unit calculates a minimum value from the jitter value obtained by said jitter value obtaining unit and sets a β value corresponding to said calculated minimum value into said target β value.

4. An optical disc apparatus according to claim 1, wherein when said optical disc is an unknown medium, said selecting unit selects said β method as said evaluation method under such a condition that the β value obtained by said β value obtaining unit satisfies said predetermined requirement for said recording power of the different intensity.

5. An optical disc apparatus according to claim 1, wherein said selecting unit selects said β method as said evaluation method in the case where a relation of a linear approximation is satisfied between the β value obtained by said β value obtaining unit and said recording power of the different intensity.

6. An optical disc apparatus according to claim 1, wherein said selecting unit selects said κ method as said evaluation method in the case where the β value obtained by said β value obtaining unit does not satisfy said predetermined requirement.

7. A selection method for evaluation methods whereby a β method using a β value showing asymmetry of an amplitude of a reproduction signal or a κ method using a modulation degree of the reproduction signal is selected as an evaluation method of evaluating recording quality of data in an optical disc, comprising the steps of:
reproducing the data recorded by a recording power of a different intensity;
obtaining the β value and a jitter value on the basis of said reproduced data;
selecting said β method as said evaluation method of evaluating the recording quality of the data in said optical disc under such a condition that said obtained β value satisfies a predetermined requirement for said recording power of the different intensity; and
setting a target β value on the basis of said obtained jitter value when said β method has been selected.

8. A selection method according to claim 7, wherein in said step of setting said target β value, a minimum value is calculated from said obtained jitter value and a β value corresponding to said calculated minimum value is set into said target β value.

9. A selection method according to claim 7, wherein in said step of selecting said β value, when said optical disc is an unknown medium, said β method is selected as said evaluation method under such a condition that said obtained β value satisfies said predetermined requirement for said recording power of the different intensity.

10. A selection method according to claim 7, wherein in said step of selecting said β value, said β method is selected as said evaluation method in the case where a relation of a linear approximation is satisfied between said obtained β value and said recording power of the different intensity.

11. A selection method according to claim 7, wherein in said step of selecting said β value, said κ method is selected as said evaluation method in the case where said obtained β value does not satisfy said predetermined requirement.
